(19) United States
(12) Patent Application Publication
(10) Pub. No.: US 2021/0216197 A1
(43) Pub. Date: Jul. 15, 2021

(54) MEDIA PLAYER FOR DISPLAYING CONTENT FROM A VIDEO SERVER AND METHOD THEREOF

(71) Applicant: Animmoov Digital Media Pvt. Ltd, New Delhi (IN)

(72) Inventors: Jainendra Kumar, New Delhi (IN); Apurva Raj, New Delhi (IN)

(21) Appl. No.: 17/135,777

(22) Filed: Dec. 28, 2020

(30) Foreign Application Priority Data
Jan. 13, 2020 (IN) 202011001544

(51) Int. Cl. G06F 3/0484; G06F 3/0488

(52) U.S. Cl. CPC G06F 3/04847; G06F 3/04886; G06F 3/04842

(57) ABSTRACT

A media player for displaying content from a video server, the media player comprising, a display means to display a user interface of the media player, a memory configured to store a plurality of instructions, a Central Processing Unit (CPU) configured to execute the plurality of instructions to display the user interface, the user interface comprising a plurality of selectable buttons to select a video linked to each of the plurality of selectable buttons on the display means, wherein each of the plurality of selectable buttons is linked to a video, play a first video linked to a first selectable button on the user interface of the media player, detect a first selection of a second selectable button of the plurality of selectable buttons by the user for viewing a second video of the second selectable button, store a current play position in a time frame of the first video in the memory, and play the second video linked to the second selectable button on the user interface, wherein the media player is configured to play the first video from the stored play position based on a second selection of the first selectable button.

### CROSS-REFERENCE TO RELATED APPLICATIONS

This application claims priority to Indian Patent Application No. 202011001544 filed Jan. 13, 2020 and entitled “MEDIA PLAYER FOR DISPLAYING CONTENT FROM A VIDEO SERVER AND METHOD THEREOF,” the entire disclosure of which is hereby incorporated for all proper purposes.

### FIELD OF THE INVENTION

The present invention is related to a new media playing device and method for providing improved user experience and in comparison to the conventional media devices.

### BACKGROUND OF THE INVENTION

As the penetration of a publicly accessible communication network, such as the Internet, continues to grow in general human life, the use, availability and distribution of media content, such as video and audio media files, via the Internet, grows as well. The popularity of delivering and experiencing media content via the Internet continues to grow because the Internet provides for both immediacy of the media and interactivity of the media.

The media content can provide a rich interactive user experience to a user via a network connected device. In some cases, media content delivered to computing devices via a network may receive input from the user to personalize and dynamically enhance the user experience, thereby further increasing the immediacy and interactivity of the medium. As such, delivering media content via the Internet is quickly gaining adoption as a mechanism for reaching consumers for purposes of marketing and monetizing media assets.

Many web-sites and media servers make media content accessible at for the users. Web-sites provide a wide range of video content varying in content type, duration and quality. Users may search, find, select and play video media when they want. Also, the web-sites and media servers can make the media content available to the users based on their search activities, such as video advertisements in a media frame of a website. Video media is also available to users from a wide range of network connected devices, such as cell phones and other mobile devices. As such, users may access video media from wherever they want. During playback of the video, users typically have control of the playing of the video via the media player. For example, the user may pause, rewind, stop or fast forward the playing of the video. However, when a media content such as a video is presented to a user in a conventional media player in a web application configured in a user device, the user can watch only single video with options to go to a “next” or a “previous” video content by means of links, buttons, or thumbnails. When the user selects any of such options, the user is directed to a corresponding video content, next or previous, and the interface of the media player reloads. Additionally, the user losses track of content in the previous video which he was watching. Therefore, if and when the user returns to the previous video, the video content reloads from the beginning of the video.

Some of the challenges with presenting the media assets over the Internet, such as simultaneous multiple videos, are due to the lack of interactive media players that can present multiple videos on a display of a user device where a user can enjoy a video content from multiple video simultaneously without being worried about loss or repetition of a previously viewed content.

### SUMMARY OF THE INVENTION

The present invention is construed in consideration to overcome the limitations of the prior conventional media players and systems.

For this purpose, it is an object of the present invention to provide a media player for displaying content from a video server, the media player comprising, a display means to display a user interface of the media player, a memory configured to store a plurality of instructions, a Central Processing Unit (CPU) configured to execute the plurality of instructions to display the user interface, the user interface comprising a plurality of selectable buttons to select a video linked to each of the plurality of selectable buttons on the display means, wherein each of the plurality of selectable buttons is linked to a video, play a first video linked to a first selectable button on the user interface of the media player, detect a first selection of a second selectable button of the plurality of selectable buttons by the user for viewing a second video of the second selectable button, store a current play position in a time frame of the first video in the memory, and play the second video linked to the second selectable button on the user interface, wherein the media player is configured to play the first video from the stored play position based on a second selection of the first selectable button.

### BRIEF DESCRIPTION OF THE DRAWINGS

FIG. 1 is an exemplary illustration of a system for providing media content to user devices.

FIG. 2 is an exemplary embodiment of the present invention displaying a media player on a user device.

FIG. 3 is an exemplary embodiment of a display of a user device where a first video is paused in the media player.

FIG. 4 is an exemplary embodiment of a display of a user device where a second video is selected in the media player by a user before complete playback of the first video.

FIG. 5 is an exemplary embodiment of the display of the user device where the second video of FIG. 4 is paused in the media player by the user.

FIG. 6 is an exemplary embodiment of a display of a user device where a second video is played in the media player after complete playback of the first video.

FIG. 7 is an exemplary embodiment of the display of the user device where the second video of FIG. 6 is paused in the media player by the user.

FIG. 8 is an exemplary implementation of media player of the present invention in a web browser.

FIG. 9 is an exemplary expansion of the media player of FIG. 8 from the miniature version to an exemplary expended version.

FIG. 10 is another embodiment where a close button of the media player of the FIG. 9 is provided with an additional media feature.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Further, throughout this disclosure, the singular terms “a,” “an,” and “the” include plural referents unless the context clearly indicates otherwise. Similarly, the word “or” is intended to include “and” unless the context clearly indicates otherwise. The word “user device” is intended to include a broad class of user devices that are configured to enable the embodiments of the present invention.

Further, numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

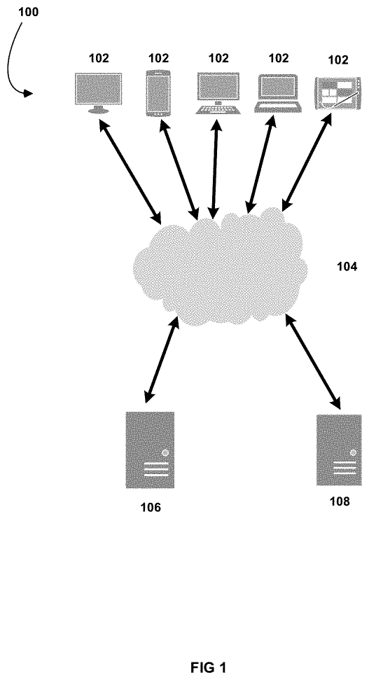

FIG. 1 illustrates an exemplary system 100 for providing media content to a user. In some implementations, the system 100 comprises a plurality of user devices 102, a content provider 106, and a web server 108. The content provider 106 provides media content such as videos that can be associate to web content provided by web server 108. The media content is provided to any of user device 102, for presentation to a user using the user device 106.

In some implementations, the content provider 106, the web server 108, and the user device 106 are in data communication across one or more networks 104. The one or more networks 104 can include local area networks, wide area networks, wired networks, wireless networks, the Internet, or any combination of the above.

Web server 108 can serve or provide access to content to the plurality of user devices 102. The content may include video files. A video file includes any content that can be visually perceived when played, decoded, or rendered. A video file can include or omit audio content, i.e. content that can be perceived aurally. A video file may be stored or streamed. The content of a video file may represent, for example, a live or recorded television program, a live or recorded theatrical or dramatic work, a music video, a televised event (e.g., a sports event, a political event, a news event, etc.), video voice mail, etc. A video file can be compressed or uncompressed.

The web server 108 can provide content for streaming and/or download to a user device 102. In some implementations, the web server 108 includes a web-based user interface, which can be accessed from a web browser application in the user device 102. The web-based user interface can include an embedded media player module for playing audio and/or video.

The content provider 106 stores information associated with media content and provides to media content creators, advertisers, or sponsors access to tools for creating and managing media content such as videos. A media content (or “advertisement” or “ad”) can be any content designed to promote a product or service, or to otherwise give public notice of some subject matter (e.g., a public service announcement, political advertising, a help wanted ad, etc.). An advertisement can include any combination of text, still graphics or images, moving graphics or images (e.g., video, animation), and audio. The advertisement can take on any of a variety of formats, including a banner, a pop-up, an overlay over other content, a video, an audio recording, for example. The advertisement may be provided by an advertiser or sponsor entity (not shown).

An advertiser can access the content provider 106 to create a video advertising campaign, including creating and/or uploading advertisements for the campaign, control the placement of the advertisements in the campaign (e.g., by targeting to particular content or categories), bid for advertisement placements, monitor statistics associated with the advertising campaign, and make payments associated with the advertising campaign. In some implementations, the content provider 106 also stores the advertisements provided or created by the advertiser as well.

A user can access content (e.g., videos) from a user device 102 via any compatible web browser applications. In some implementations, the user device 102 includes a client application. In some implementations, the client application is a web browser application that can render and present a web-based user interface of the web server 108. The user device 102 can download and/or stream content for presentation to a user and/or storage. A user device 102 can include input (e.g., keyboard, mouse, touch-sensitive display, etc.) and output devices (display device, audio output device, etc.). Some non-limiting examples of the plurality of user devices 102 include desktop computers, notebook computers, tablet computers, network terminals, personal digital assistants (PDA), mobile phones, smartphones, set top boxes, television devices and multimedia players.

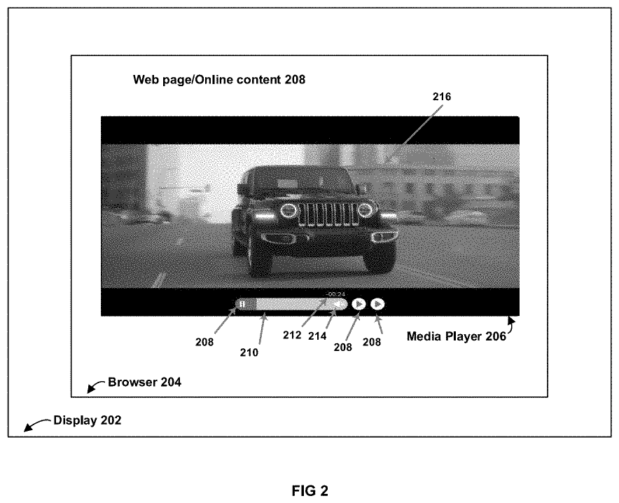

FIG. 2 discloses one exemplary embodiment of the present invention on a display 202 of a user device 102. The content provider 106 delivers video/media content and/or advertisement to a user device 102 via a media player 206. With reference to FIG. 1, an exemplary embodiment of a display 202 of a user device 102 for receiving delivery of video content and/or ads and displaying the received is depicted. In brief overview, the display 202 comprises a web browser 204 for connecting to, communicating with and receiving content via a network 104 from one or more web servers 108 in connection with content provider 106. The user device 102 is connected to a website via the browser 204.

Once connected, the website presents web content 208 in form of a webpage. The web content 208 comprises a portion in the webpage where the media player 206 can be embedded. The portion can be anywhere in the webpage for the purpose of this invention. However, in a preferred embodiment, the media player 206 is placed at a position of high user visibility at the webpage.

In a further embodiment, the media player 206 is embedded and configured in an expendable mode where the media player 206 expends from a small size to a predetermined dimension relative to the display 202 based on a user input, such as hovering the mouse pointer over the small sized media player 206 or mouse click.

In some embodiments, web browser 204, or media player 206 can access offline content via memory or storage accessible by user device 102, such as via a cache.

In other embodiments, the web browser 204 or media player 206 provides access to both online and offline content.

The web browser 204 comprises any type and/or form of application, program, service, library, process, or set of executable instructions for accessing content via a network, such as the Internet using uniform resource locators. The web browser 204 may include any type and form of graphical user interface. The web browser 204 may be, for example, a Microsoft® Internet Explorer browser and/or Netscape™ browser, or a FireFox browser.

In an embodiment, the media player 206 or application provides access to or plays downloaded or offline content. In some embodiment, the media player 206 accesses content or receive delivery of content via a network 104. In one embodiment, the media player 206 provides access to both online and offline content.

The media player 206 comprises any type and/or form of software, hardware, or combination of software and hardware for experiencing, running, or otherwise playing a media in any form, such as various types and forms of information and data, electronic, digital or otherwise, for conveying information via text, audio, graphics, animation, video and/or interactivity.

The media player 206 of the present invention comprises a graphic user interface (GUI) 216 to display the media content. The GUI 216 comprises a plurality of selectable buttons 208 superimposed over a video playing layer 216. Each of the plurality of selectable buttons 208 is linked to a video independent to a video of other selectable button. The videos can be linked to the plurality of selectable buttons based on advertiser's preference, user search history, or predetermined criteria. The selectable buttons 208 receive user input and perform functions based on received input. The number of selectable buttons 208 in the GUI 216 is non-limiting for the purpose of the invention. However, a preferred range of number of selectable buttons 208 is 3-10.

Initial Stage:

When the web content loads at the time of user visiting the webpage, the media player 206 starts receiving video content corresponding to selectable buttons 208. Once the video content is received, a preferred video and its corresponding selectable button 208 activates and starts playing the video. The preferred video can be any video linked to the selectable buttons 208 based on a configuration of the media player. However, a video linked to a first selectable button 208 is a preferred video to start in the beginning.

After the preferred video starts, the corresponding selectable button 208 expends providing time duration of remaining video content in the presently playing video. Additionally, a portion of the expended turns to a “pause” function. The “pause” function, when enabled, holds the playing of the video at a current play position. A sound disable function can also be provided in the expended selectable button 208 to mute a sound of presently playing video.

Additionally in a further embodiment, when a selectable button 208 is in operation i.e. selected by a user or automatically started playing a linked video, the operational selectable button 208 can expand into a media streaming bar 210 that displays a remaining amount of duration of presently playing video via a streaming status in the streaming bar 210 and/or a timer 312 inside or outside the streaming bar 210. The streaming bar 210 can also comprise a mute button 214 to mute a sound of the presently playing video.

A functionality to fast forward the presently playing video is disabled in the present invention to draw complete attention of the user on the contents of the presently playing video.

The selectable buttons 208 other than the selectable button 208 a linked video is presently being played on the GUI 216 remain at active state and waiting to receive a user input or completion of playback of the presently playing video.

Video Playback:

After the playback of the preferred video starts, the user can be provided with two playback options. The user can either watch the presently playing video completely or can select any other selectable button 208 to change the video.

When User Watches the Presently Playing Video:

When the user chooses to watch the presently playing video completely, the media player 206 playback the video completely till its time duration. When the playback ends at the finish of the video, the media player is configured to automatically select a second video linked to a second selectable button 208 from the provided plurality of selectable buttons 208. The second selectable button 208 can be a next selectable button 208 to the selectable button 208 of which the video was previously played or any other selectable button based on the configuration of the media player 206 or content provider 106.

The playback can be sequential where, after completion of a video, the next video is played in a sequence of position of their corresponding selectable buttons 208.

When in operation and an active state, the second selectable button 208 starts functioning like the first selectable button 208 and the “play” function of the first selectable button 208 turns to a “replay” function. The replay function when used starts playing a video from its initial position in the time duration.

When User Switches to a Next Video Before Completion of the Presently Playing Video:

When the user wants to switch from one video to other before a completion of playback of presently playing video, the media player 206 detects a selection of a selection button 208. This selection is user preferred input for a video linked to one of the other selectable buttons.

When a selection is detected, the media player 206 stores the present playing position in the time duration of the presently playing video in a memory. Once the play position is saved, the media player 206 updates the GUI, loads a video linked to the user selected button, and start the playback.

When in operation and an active state, the user selected button 208 starts functioning like the previous selectable button 208 from which the video playback is switched. The previous selectable button 208, because the playback was not completed, remains at a “play” function and user can switch back to the previously playing video. The media player 206 retrieves the stored play position of the previously playing video from the memory and starts playback of the previous video from the position where the selection of second selectable button 208 was detected.

The media type and format of the videos linked to the selectable buttons 208 is non-limiting for the scope of the present invention. However, non-limiting examples of type and/or format of the video content may include a container format such as 3gp, AVI, ASF, Matroska, MOV, MP4, NUT, Ogg, RealMedia, a video codec such as 3ivx, Cinepak, DivX, DV, H.263, H.264/MPEG-4 AVC, HuffYUV, Indeo, MJPEG, MPEG-1, MPEG-2, MPEG-4, RealVideo, Sorenson, Theora, WMV, XviD, and/or audio codecs, such as AAC, AC3, ALAC, AMR, FLAC, MP3, RealAudio, Shorten, Speex, Vorbis, and WMA. In these embodiments, the media player 206 may read and process a media of any type and/or format.

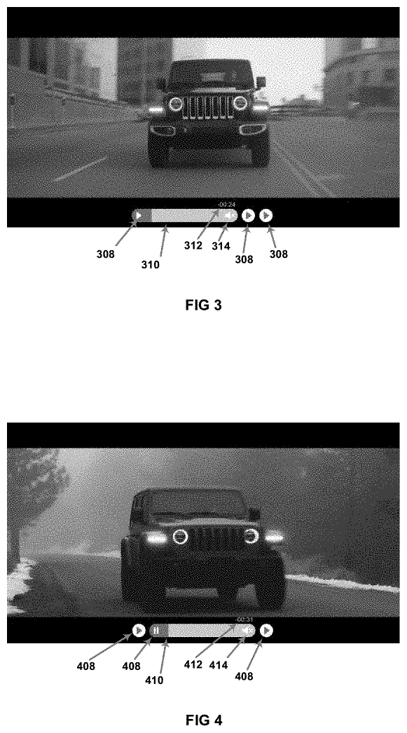

FIG. 3 discloses an exemplary illustration of the media player 206 of FIG. 2 where the first selectable button 208 is clicked by the user to pause the playback of presently paying video. When clicked during a playback of the presently playing video, a first selectable button 308 turns to a “paused” mode where the video pauses at a presently play position and media player 206 waits for an input from the user. The media player 206 can resume playback based on a trigger such as dedicated user input or lapse of a predetermined waiting time period. In the media player 206 disclosed in FIG. 3, a plurality of selectable buttons 308, a media streaming bar 310, a timer 312, a mute button 314 have same mode of operation as disclosed in FIG. 2 for the plurality of selectable buttons 208, the media streaming bar 210, a timer 212, a mute button 214.

FIG. 4 discloses another exemplary illustration of the media player 206 of FIG. 2 where the second selectable button 408 is clicked by the user to a playback of linked video of the second selectable button 408. When the second selectable button 408 is clicked by the user during a playback of a video of first selectable button 408, a first selectable button 408 turns to a “paused” mode where the video pauses at a presently play position and media player 206 starts a playback of video linked to the second selectable button 408. In the media player 206 disclosed in FIG. 4, a plurality of selectable buttons 408, a media streaming bar 410, a timer 412, a mute button 414 have same mode of operation as disclosed in FIG. 2 for the plurality of selectable buttons 208, the media streaming bar 210, a timer 212, a mute button 214.

FIG. 5 discloses another exemplary illustration of the media player 206 of FIG. 4 where the second selectable button 508 clicked by the user to pause the playback of presently paying video linked to the second selectable button 508. When clicked during a playback of the presently playing video, a second selectable button 508 turns to a “paused” mode where the video pauses at a presently play position and media player 206 waits for an input from the user. The media player 206 can resume playback based on a trigger such as dedicated user input or lapse of a predetermined waiting time period. In the media player 206 disclosed in FIG. 2, a plurality of selectable buttons 508, a media streaming bar 510, a timer 512, a mute button 514 have same mode of operation as disclosed in FIG. 2 for the plurality of selectable buttons 208, the media streaming bar 210, a timer 212, a mute button 214.

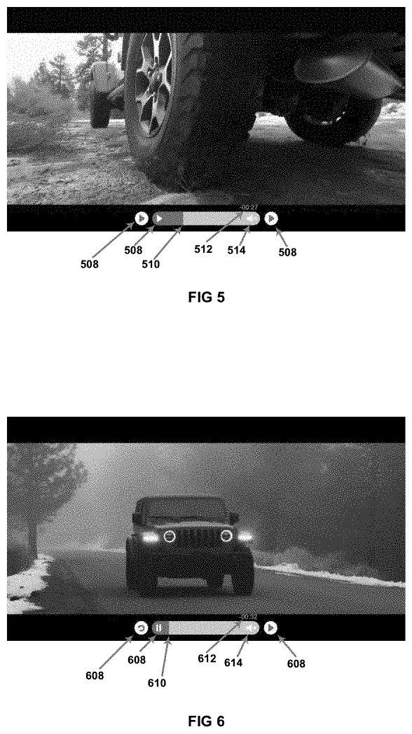

FIG. 6 discloses another exemplary illustration of the media player 206 of FIG. 2 where the second selectable button 608 starts a playback of linked video of the second selectable button 608 after an automatic completion of video linked to the first selectable button 608. When the second selectable button 408 starts operation, media player 206 starts a playback of video linked to the second selectable button 608 and the first selectable button 608 turns to a “replay” mode where the linked video starts a playback from a beginning play position when a user selects the first selectable button 608. In the media player 206 disclosed in FIG. 6, a plurality of selectable buttons 608, a media streaming bar 610, a timer 612, a mute button 614 have same mode of operation as disclosed in FIG. 2 for the plurality of selectable buttons 208, the media streaming bar 210, a timer 212, a mute button 214.

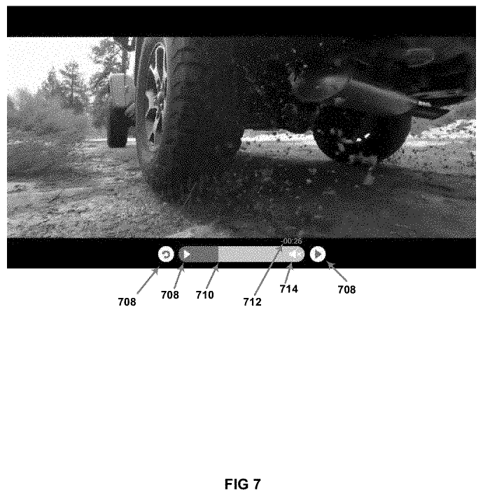

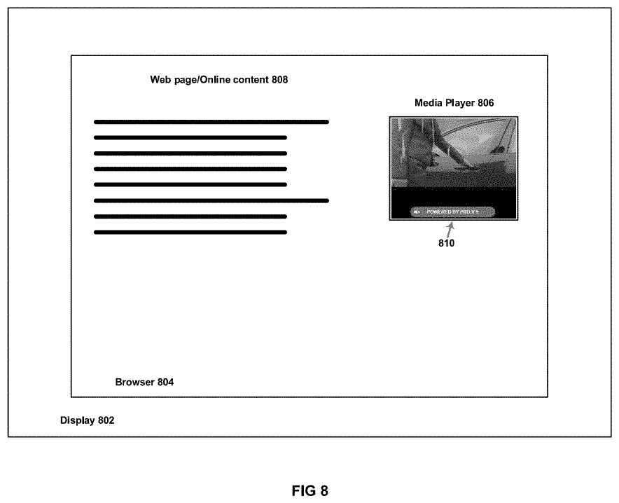

FIG. 7 discloses another exemplary illustration of the media player 206 of FIG. 6 where the second selectable button 708 clicked by the user to pause the playback of presently paying video linked to the second selectable button 708. When clicked during a playback of the presently playing video, a second selectable button 708 turns to a “paused” mode where the video pauses at a presently play position and media player 206 waits for an input from the user. The media player 206 can resume playback based on a trigger such as dedicated user input or lapse of a predetermined waiting time period. In the media player 206 disclosed in FIG. 7, a plurality of selectable buttons 708, a media streaming bar 710, a timer 712, a mute button 714 have same mode of operation as disclosed in FIG. 2 for the plurality of selectable buttons 208, the media streaming bar 210, a timer 212, a mute button 214.

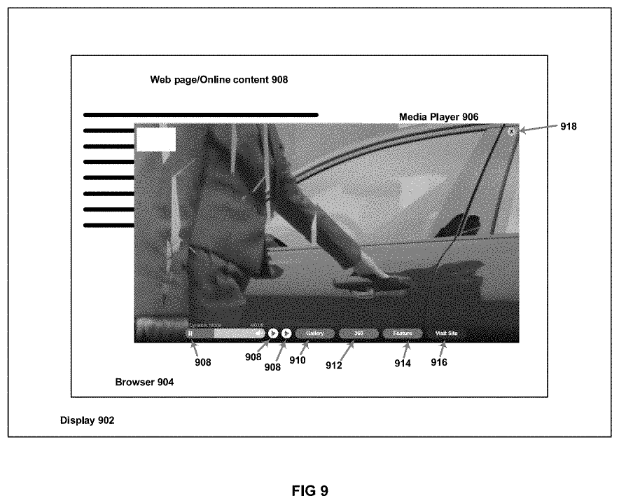

FIG. 8 is another exemplary implementation of media player 806 in a web browser 804 on a display 802 of a user device (not disclosed) in combination with online content 808 in a webpage. The media player 806 is implemented as a miniature version and a “call to action” button 810 is provided for a user to click or hover. When a user clicks or hovers an input pointer such as a mouse pointer, the media player 806 expends from the miniature state to an expended form, an exemplary illustration of which is provided in FIG. 9. The miniature version of media player 806 can display media such as teaser videos, one or more images, or an advertisement.

FIG. 9 is an exemplary expansion of media player 806 of FIG. 8 from the miniature version as a media player 906. Based on user's clicking or hovering an input pointer such as a mouse pointer, the media player 806 expends from the miniature state to an expended form as media player 906 and starts operation of a media player 206 as disclosed in FIG. 2. In the media player 906 disclosed in FIG. 9, a plurality of selectable buttons 908, have same mode of operation as disclosed in FIG. 2 for the plurality of selectable buttons 208. Additional buttons or links can be provided at a left side or a right side of the plurality of selectable buttons 908 based on configuration and/or preferences of the content providers 106 or advertisers such as a gallery button 910 to display a media gallery and media content, a 360 degree view button 912 to provide a 360 degree view of a product in one or more videos linked to the selectable buttons 908, a feature button 914 to provide a list of features of the product in one or more videos linked to the selectable buttons 908, and or a web link 916 to redirect the user to a preconfigured webpage when selected by the user. A close button 918 can also be provided to close the media player.

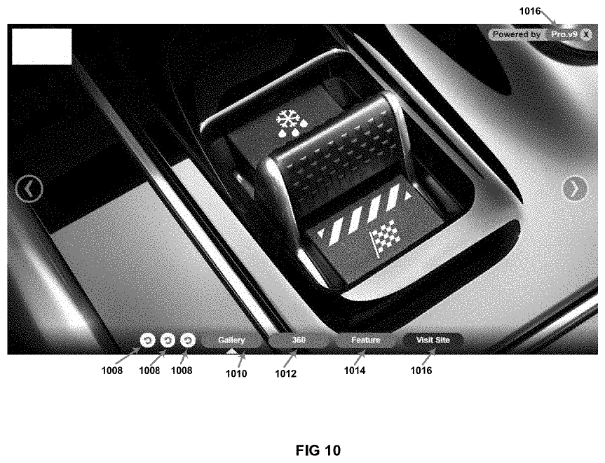

FIG. 10 is another embodiment where a close button 1016 of the media player 906 of the FIG. 9 is provided with an additional media feature. When the user hovers an input pointer such as a mouse pointer in a predetermined area in proximity of the close button 1016, the close button 1016 expends and the additional media feature is displayed to the user. The additional media feature can be a predetermined text or a media content such as an image or a short duration branding video.

Further, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims.

Further, although the present invention has been described herein in the context of particular embodiments and implementations and applications and examples and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A media player for displaying content from a video server, the media player comprising:
a display means to display a user interface of the media player;
a memory configured to store a plurality of instructions;
a Central Processing Unit (CPU) configured to execute the plurality of instructions to:
display the user interface, the user interface comprising a plurality of selectable buttons to select a video linked to each of the plurality of selectable buttons on the display means, wherein each of the plurality of selectable buttons is linked to a video;
play a first video linked to a first selectable button on the user interface of the media player;
detect a first selection of a second selectable button of the plurality of selectable buttons by the user for viewing a second video of the second selectable button;
store a current play position in a time frame of the first video in the memory; and
play the second video linked to the second selectable button on the user interface,
wherein the media player is configured to play the first video from the stored play position based on a second selection of the first selectable button.

2. The media player as claimed in claim 1, wherein the media playing device is configured to convert a selectable button to a replay button after a playback of corresponding video is complete.

3. The media player as claimed in claim 1, wherein the first video and the second video are from a same video server.

4. The media player as claimed in claim 1, wherein the first video and the second video are from different video servers.

5. The media player as claimed in claim 1, wherein the plurality of selectable buttons are superimposed over a portion of the user interface.

6. The media player as claimed in claim 1, wherein the time frame of the first video is a total time duration of playback of the first video.

7. The media player as claimed in claim 6, wherein the current play position of the first video is a streaming position of the first video at a time of detection of the first selection.

8. The media player as claimed in claim 1, wherein the media player is configured to play in a predetermined sequence in absence of the first selection or the second selection.

9. A method of playing videos in a media player, the method comprising:
displaying a user interface of the media player comprising a plurality of selectable buttons to select a video linked to each of the plurality of selectable buttons on the display means, wherein each of the plurality of selectable buttons is linked to a video,
playing a first video linked to a first selectable button on the user interface,
detecting a first selection of a second selectable button of the plurality of selectable buttons by a user for viewing a second video of the second selectable button,
storing a current play position in a time frame of the first video, and
playing the second video linked to the second selectable button on the user interface,
wherein the media player plays the first video from the stored play position based on a second selection of the first selectable button.

10. The method as claimed in claim 9, wherein the current play position of the first video is a streaming position of the first video at a time of detection of the first selection.
